(19) United States
(12) Patent Application Publication
(10) Pub. No.: US 2006/0082807 A1
(43) Pub. Date: Apr. 20, 2006

(54) Method and system for printing electronic mail

(76) Inventors: Yokichi Joe Tanaka, Forthill Ranch, CA (US); Don Francis Purpura, Yorba Linda, CA (US); Amy Hye-sook Lee, Cypress, CA (US); Bret Haywood Hassler, Mission Viejo, CA (US)

Correspondence Address: Canon U.S.A. Inc.,;Intellectual Property Department, 15975 Alton Parkway, Irvine, CA, 92618, US

(21) Appl. No.: 10/943,336

(22) Filed: Sep. 17, 2004

(51) Int. Cl. G06F 3/12; G06F 15/00

(52) U.S. Cl. 358/1.15

(57) ABSTRACT

Printing an electronic document by dynamically creating a destination identifier and transmitting the electronic document with the destination identifier to a destination e-mail address. A server dynamically stores the electronic document with the associated destination identifier and waits to receive the identification-account information from an input device. An agent verifies the inputted identification-account information with the destination identifier stored on the server. The electronic document(s) associated with the destination identifier is then sent to the printer for printing upon verification.

### BACKGROUND OF THE INVENTION

1. Field of the Invention

The present invention is generally related to ad-hoc printing, and more specifically, is related to a method and system for ad-hoc printing via an electronic mail system.

2. Description of the Related Art

Recently, handheld mobile devices such as Personal Digital Assistants (i.e., PDAs) and BlackBerrys® have become increasingly popular. Such devices increase user mobility by providing computer software that allows users to wirelessly transmit and receive electronic mail (hereinafter referred to as “e-mail”). Unfortunately, these handheld mobile devices have limited capabilities due to their limited processing power, limited memory, and limited display capabilities. As a result, these types of devices do not have the capacity to execute a viewer application for viewing e-mail attachments. Thus, users can encounter problems when attempting to view e-mail attachments and/or remotely print the attachments from a handheld mobile device.

In another scenario, notebook computer users may find themselves at a remote location where they do not have access to printers they typically use. Although notebook computers have sufficient computing capabilities to print an e-mail attachment, the appropriate printer driver for the printer at the remote location may not be installed on the notebook computer. In such cases, users may be prevented from using the remote location's printer(s).

U.S. published application No. 2003/0011809 describes a method and system for printing over a network. More specifically, the invention relates to uploading a print job consisting of print data and associated credit card information onto a network server, and retrieving the print job from the server at a printing device (i.e. printer) by using a credit card as a means of identifying the person printing the job. Prior to uploading the document, however, a user must access a webpage of a system operator where the user inputs print data by selecting a file stored on a host computer, and must also input the credit card information on the webpage. Such a system requires a user to establish a pre-existing relation with the server (i.e., pre-registration) prior to printing. In a case where the user fails to upload the document or input the credit card information, the user may be prevented from printing.

Currently, in many instances, a user will need to print a sensitive document to a remote printer, where the remote printer is a public printer. And, in most of those instances, the remote printer, upon receipt of the document, will proceed to print the document. This results in anyone being able to view and/or pick-up the sensitive document before the user arrives at the printer to retrieve the document. Therefore, under certain circumstances, when performing remote printing, it is desirable to initiate the actual printing function after the user arrives at the targeted printer.

There are also currently circumstances where a user wishes to remotely print an electronic document, but is in a location where payment is required in order to enable printing (i.e., business center of a hotel). Under this scenario, the printing system may require a user to submit payment information (i.e., credit card information) along with the print job. This however, creates the possibility that the user's confidential payment information may be intercepted by an interloper. In spite of this, the user usually has no choice but to send this information if the user wishes to print the document.

### SUMMARY OF THE INVENTION

The present invention addresses the foregoing by transmitting an electronic document and a destination identifier via e-mail to a destination e-mail address located at a server. The server dynamically allocates storage space for each e-mail, the electronic document, and document identifier transmitted to the destination e-mail address. An automatic notification e-mail is generated from the server in response to storing the e-mail, electronic document, and destination identifier. The destination identifier may be dynamically created by a user, and is preferably comprised of at least a user-identifier and an identification-code. The destination identifier may be contained in the destination e-mail address or in the e-mail message, such as the subject line of the e-mail message. The user-identifier may be the first and last name of a user and the identification-code may be a credit card number, debit card number, prepaid card number or any other identification account number. Preferably, only a portion of or the last 4-digits of the identification account number is required.

After transmitting the e-mail to the destination e-mail address, the user may swipe a card that contains the user-identifier and identification-code at a card reader connected to a printing device to retrieve the electronic document from the server. In response to swiping the card, a network interface device checks if the information on the card matches with the user-identifier and identification-code of the destination identifier. In a case where a match is found, the printing device retrieves the electronic document associated with the destination identifier from the server. The user then selects and prints the electronic document.

In another embodiment, the user manually enters the user's name and identification account information at the printing device to retrieve the electronic document from the server. In response to entering the user information and identification account information, a verification agent checks if the entered information matches with the user-identifier and identification-code of the destination identifier. In a case where a match is found, the printing device retrieves the electronic document associated with the destination identifier from the server. The user then selects and prints the electronic document.

In another embodiment, the present invention allows a user to transmit multiple electronic documents associated with the same destination identifier to the server, where the documents will remain on the server for a predetermined amount of time. In response to a user inputting identification account information at a printing device, the list of print jobs available for printing associated with the destination identifier are displayed at the printing device. The user then selects and prints the desired document.

In yet another embodiment, the invention further includes a transaction agent. In response to a user selecting the desired document to print, the transaction agent determines the price for printing the document and displays the price to the user. Determination of the price includes, but is not limited to, printing options such as paper size, color copies, number of copies, etc. If the user wishes to proceed with printing the document, the transaction agent verifies the payment method with the identification account information. In response to verification, the transaction agent executes the payment at the determined price and initiates printing of the document.

As a result of the present invention, a user can perform ad-hoc printing via an e-mail system by sending an e-mail containing an electronic document and a destination identifier to a destination e-mail address located at a server without requiring any prior registration procedures, and then retrieving and printing the document at a printer.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 depicts a network environment in which the invention may be employed.

FIG. 2 is a block diagram depicting an internal architecture of a mobile handheld device used for transmitting an electronic document according to the invention.

FIG. 3 is a block diagram depicting an internal architecture of a Mobile Print Service (MPS) server.

FIG. 4 is a block diagram depicting an internal architecture of a network interface device for printing a print job according to the invention.

FIG. 5 is a flowchart depicting the process for transmitting an electronic document to the server and printing the document at a printer.

FIG. 6 is a flowchart of process steps performed by an MPS server according to the invention.

FIG. 7 depicts an example of dynamically creating a destination identifier.

### DETAILED DESCRIPTION OF THE PREFERRED EMBODIMENTS

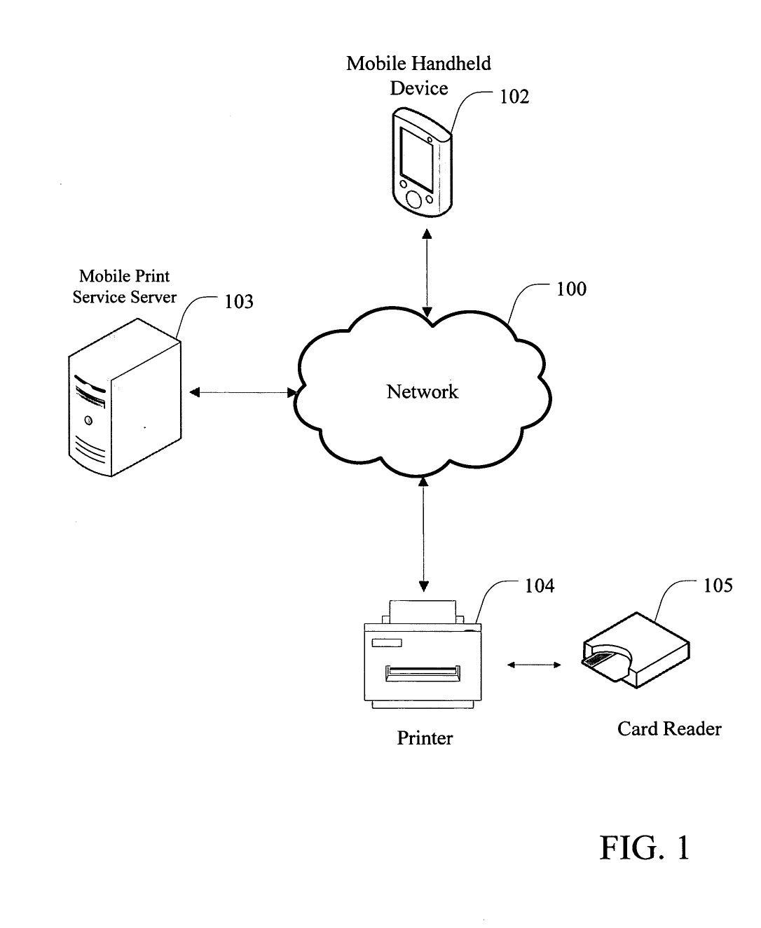

FIG. 1 depicts one example of a network environment in which the invention may be employed. Network 100 depicted in FIG. 1 is preferably the Internet, but is not limited to such, and any network environment that would enable practice of the present invention is applicable. As shown in FIG. 1, network 100 (i.e. the Internet) provides for communication between various entities. Each of the entities 102 to 105 is connected to network 100 either physically or wirelessly. Thus, each of the entities 102 to 105 may communicate with each other via network 100 from different locations such as a hotel, a user's home/office, an Internet printing service provider, etc. For instance, print data may be transferred from a home/office (not shown) to Mobile Print Service (MPS) server 103, and then to a hotel (not shown) via network 100 from the MPS 103.

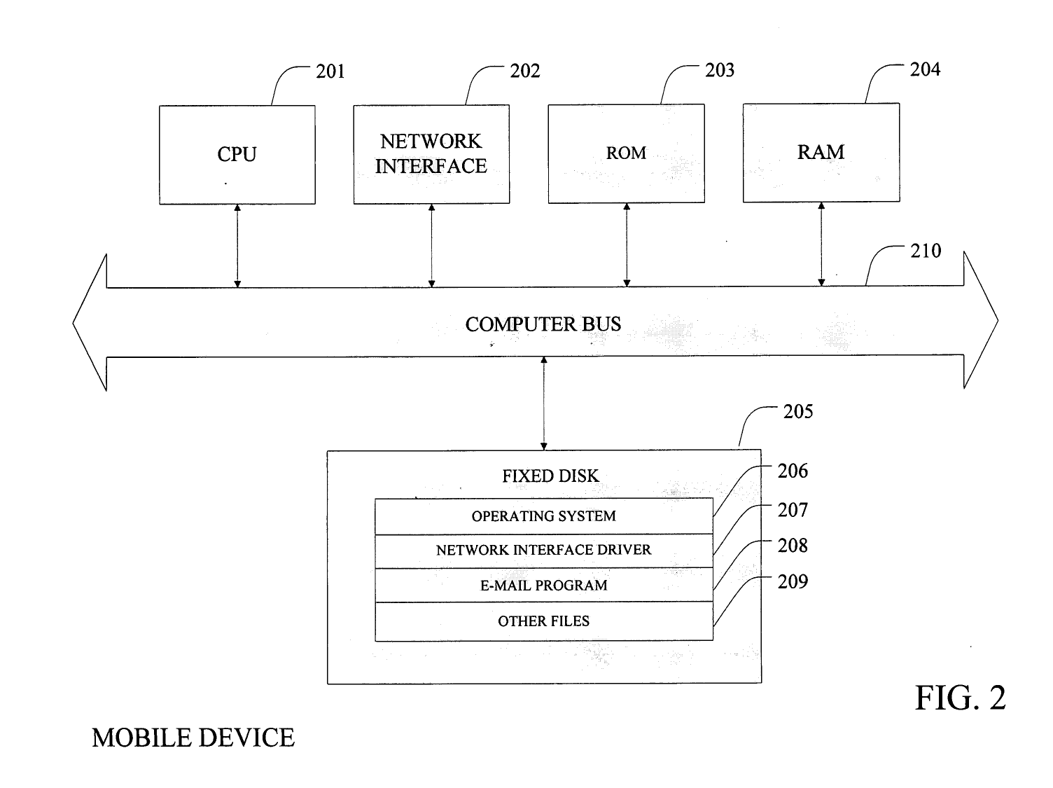

Mobile handheld device 102 may be a PDA, BlackBerry®, cellular phone, laptop computer, or any device that is capable of transmitting e-mail over network 100. Mobile handheld device 102 will be discussed in more detail with respect to FIG. 2. Card reader 105 may be a magnetic stripe card reader such as a credit card reader, a smart card reader, a recorded medium reader. In another embodiment, a manual input device such as a touch screen monitor can replace card reader 105. In general, any input device that would allow practice of the present invention is applicable.

FIG. 2 depicts an example of an internal architecture of a mobile handheld device 102. The architecture of a mobile handheld device 102 preferably includes a central processing unit (CPU) 201, where CPU 201 is connected to computer bus 210. Also connected to computer bus 210 is a network interface 202. Network interface 202 allows mobile handheld device 102 to be interfaced with network 100 through a wired or wireless connection (not shown). Random access memory (RAM) 204, fixed disk 205, and read-only memory (ROM) 203 are connected to computer bus 210 and provide CPU 201 with access to memory storage. In particular, when executing stored program instruction sequences, CPU 201 loads those instruction sequences from fixed disk 205 into RAM 204 and executes those stored program instruction sequence out of RAM 204. It should also be recognized that standard disk-swapping techniques allow segments of memory to be swapped to and from RAM 204 and fixed disk 205.

Fixed disk 205 includes an operating system, a network interface driver executable on the operating system 206, a network interface driver 207, an e-mail application 208, and other files 209. Operating system 206 can be any operating system, such as a windowing operating system. Network interface driver 207 is utilized to enable network interface 202 to connect mobile handheld device 102 with network 100. E-mail program 208 is a typical e-mail program for sending/receiving e-mail messages. Other files 209 contain files or programs necessary for the operation of mobile handheld device 102.

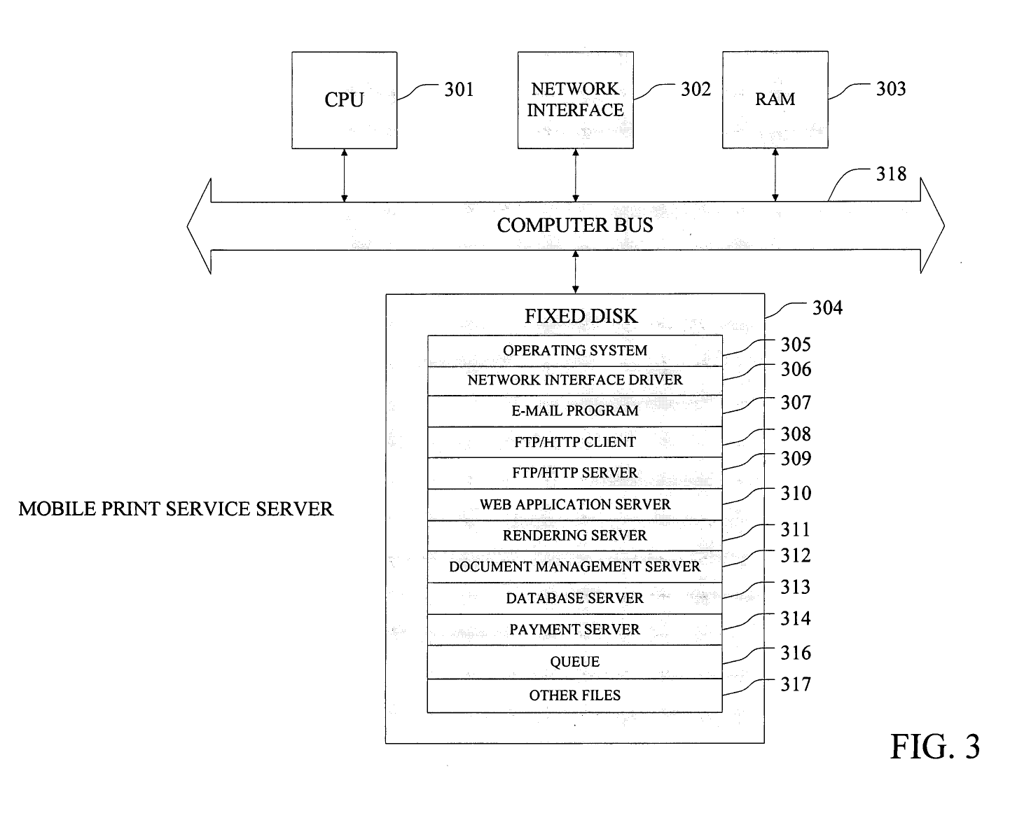

FIG. 3 depicts an example of an internal architecture of MPS server 103. The architecture of MPS server 103 preferably includes CPU 301, which is interfaced to computer bus 318. Also coupled to computer bus 318 is network interface 302. In addition, RAM 303 and fixed disk 304 are also interfaced to computer bus 318 to provide CPU 301 with access to memory storage. In particular, when executing stored program instruction sequences, CPU 301 loads the instruction sequences from fixed disk 304 into RAM 303 and executes the stored program instruction sequence out of RAM 303. It should also be recognized that standard disk-swapping techniques allow segments of memory to be swapped to and from RAM 303 and fixed disk 304.

Fixed disk 304 includes operating system 305, network interface driver 306, e-mail application 307, FTP/HTTP client 308, FTP/HTTP server 309, web application server 310, rendering server 311, document management server 312, database server 313, payment server 314, queue 316, and other files 317.

Operating system 305 can be an operating system, such as a windows operating system. Network interface driver 306 is utilized to enable network interface 302 to connect MPS server 103 to network 100. E-mail program 307 is a typical e-mail program for sending/receiving e-mail messages. FTP/HTTP client 308 provides MPS server 103 with the ability to transmit and receive data files via FTP and HTTP protocols over network 100 through network interface 302. FTP/HTTP server 309 can be accessed by an FTP/HTTP client of device, such as printer 104, mobile handheld device 102, or network interface device 400. Web application server 310 acts to provide MPS server 103 with functionality as a server on the Internet. As such, web application server 310 includes a network address that identifies server on the Internet. Rendering server 311 is the component that utilizes automation servers such as Microsoft Office Automation objects and Adobe PDF automation objects to render documents from their original format to a print ready format for printing. Document management server 312 is a document management system that utilizes NT file system (NTFS) to organize files into directories. Database server 313 is used to store destination e-mail address, source e-mail address, destination identifier, file data (i.e. electronic document), history data, device information and user session information. The database server is preferably a Microsoft SQL Server, but any database server may be utilized. Payment server 314 is used to provide secure payment transactions. It may include a transaction agent (not shown), a software program designed for calculating, displaying and executing payment information. Depending on the functionality of the printer, the transaction agent further provides finishing options corresponding to the printer such as paper size, color copies, number of copies, etc. Payment server 314 is preferably supported by secure payment gateway such as VeriSign®. Queue 316 is utilized to store numerous print jobs that may be transmitted to server 103. Other files 317 contain other files or programs necessary to operate server 103 and/or to provide additional functionality to server 103.

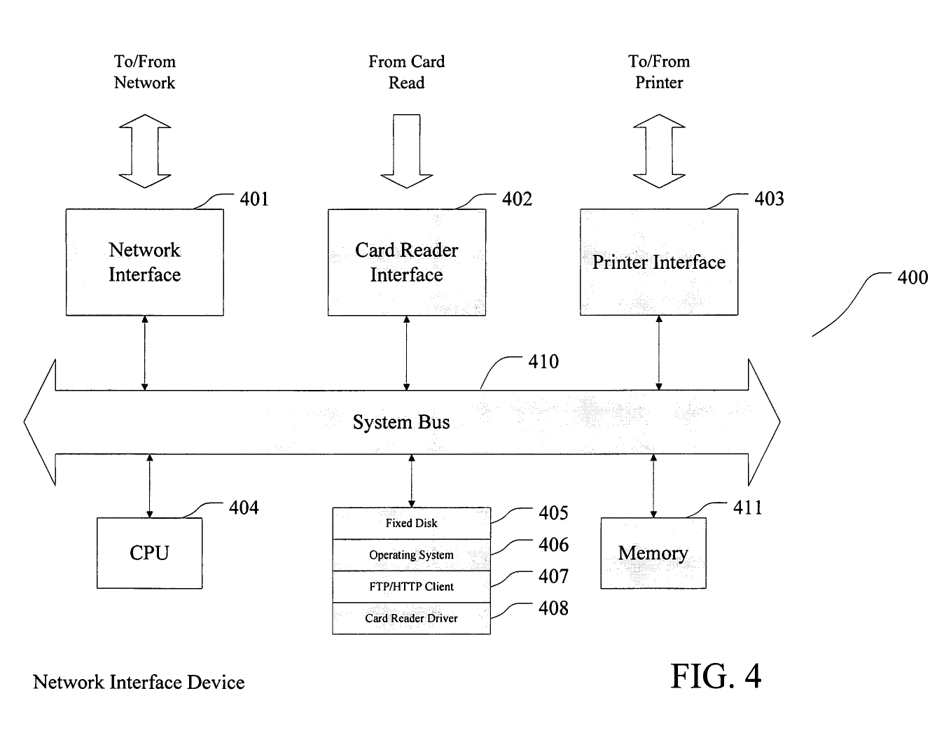

FIG. 4 depicts an example of an internal architecture of network interface device 400. As stated above, network interface device 400 may be a device external to a printer, or may be incorporated into the printer. Regardless of whether the device is external to or incorporated in a printer, the functionality and architecture of the network interface device is the same. As seen in FIG. 4, the internal architecture of network interface device 400 is similar to that of a personal computer. It includes CPU 404, memory 411, network interface 401, card reader interface 402, printer interface 403, and fixed disk 405, all of which are connected to system bus 410.

Network interface 401 preferably utilizes Secure Sockets Layer (SSL) protocol for transmitting and receiving information (i.e. e-mail, credit card information) via network 100. Card reader interface 402 is connected to card reader 105 for interfacing with a card reader. Printer interface 403 may be a serial connection, parallel connection, USB connection, or a network connection connected to printer for transmitting data to printer 104.

Fixed disk 405 is preferably a hard disk similar to fixed disk 304, but may be a solid state memory instead, such as a flash memory. Fixed disk 405 includes operating system 406, FTP/HTTP client 407, and card reader driver 406. Operating system 406 is preferably an embedded operating system, such as Linux or VXWorks, but may be any other type of operating system which includes functionality for transmitting credit card information over network 100 to MPS server 103 and for receiving and submitting print data to printer 104 for printing. FTP/HTTP client 308 provides server 103 with the ability to transmit and retrieve data files via FTP (File Transfer Protocol) and HTTP (Hypertext Transport Protocol) protocols over the network through network interface 302. Additionally, FTP/HTTP server 309 of server 103 can be accessed by an FTP/HTTP client of a printer or any other type of device, such as network interface device. Card reader driver 408 is utilized for interfacing with card reader 105. Network interface device 400 preferably utilizes Secure Sockets Layer (SSL) to securely transmit credit card information and to receive print data via network interface 401.

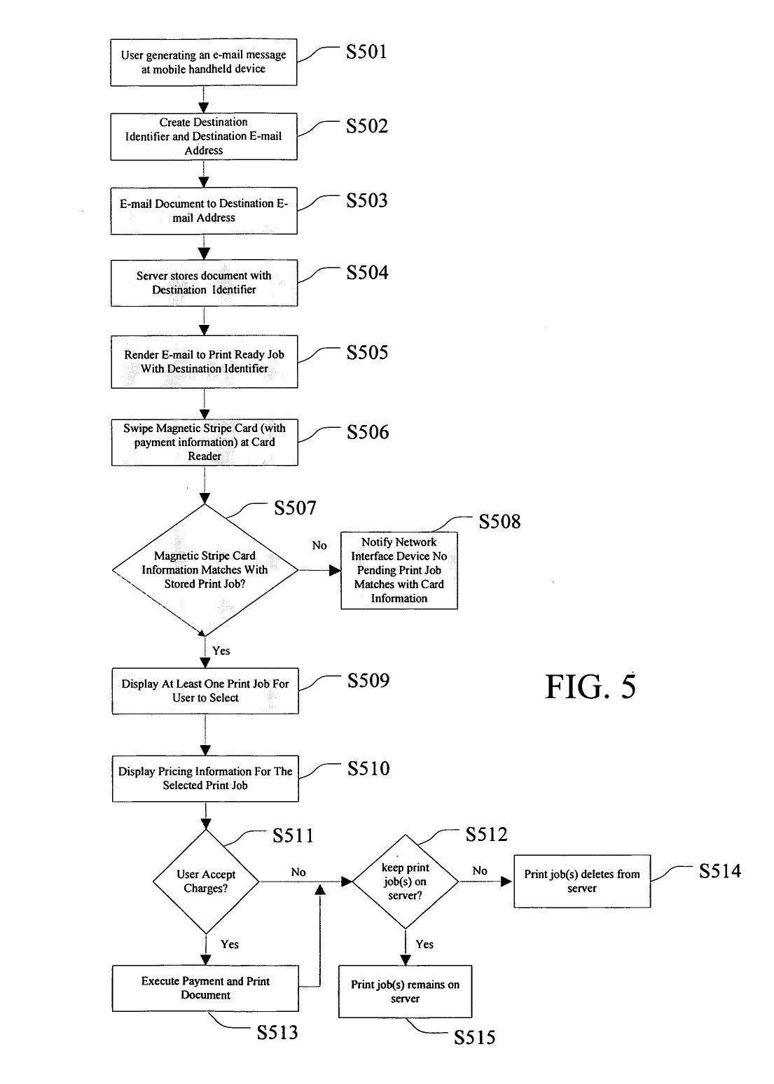

FIG. 5 is a flowchart depicting one embodiment of the present invention. Briefly, an e-mail with an electronic document and destination identifier is transmitted to a destination e-mail address on a server, where the server stores the e-mail, electronic document, and destination identifier. To retrieve and print the document, a user provides user identification information to the server, which is verified with the destination identifier. If the verification passes, the document is retrieved and printed.

In more detail, the process begins in step S501 with a user generating an e-mail message at mobile handheld device 102. The e-mail message preferably contains an electronic document as an attachment. Next, in step S502, the user creates a destination identifier and a destination e-mail address. The destination identifier is preferably dynamically created by the user, and preferably comprises at least a user-identifier and an identification-code. For example, the user-identifier may be the first and last name of the user. In addition, the user-identifier may further include the user's complete or partial home address. The identification-code of the destination identifier may be a credit card number, debit card number, prepaid card number or any other identification account number. Preferably, only a portion of or the last 4-digits of the identification account number is used.

The destination identifier is preferably contained in the identifier portion of the destination e-mail address. However, the destination identifier may be included in any part of the e-mail message, such as the subject field or the message body of the e-mail message. If the destination identifier is contained in the subject field or the message body, the identifier portion of the destination e-mail address can be a printer name or a print service provider name such as “Canon®”. For example, “canon@mps.com”.

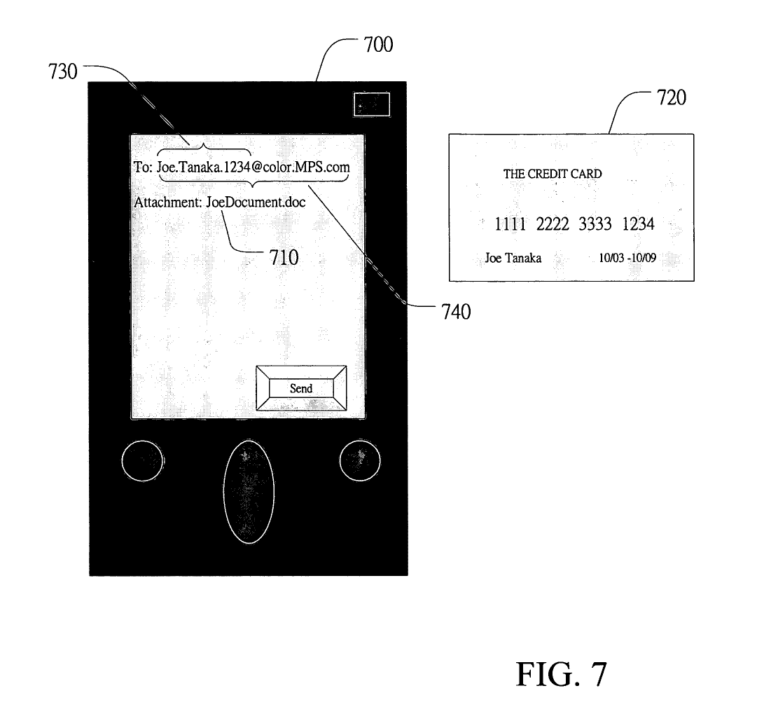

An example of dynamically creating a destination identifier is illustrated in FIG. 7. FIG. 7 depicts a personal digital assistant 700 and a user's credit card 720. The destination identifier 730 (Joe.Tanaka.1234) is created by combining the user's name and the last 4-digits of the user's credit card number. The user-identifier portion of the destination identifier in FIG. 7 is the user's first and last name (Joe.Tanaka). The identification-code of the destination identifier is the last 4-digits of the user's credit card number (1234). Using destination identifier 730, destination e-mail address 740 is created by combining the destination identifier with a domain server name (MPS.com) associated with the user's e-mail account. Destination e-mail address 740 may further include a sub-domain name (e.g., color) to prompt the MPS server 103 to provide the cost for printing the print job in color. Thereafter, the user can proceed with transmitting an electronic document to the MPS server 103 by transmitting an electronic document as an e-mail attachment 710 to destination e-mail address 730 over network 100.

Returning to the flow of FIG. 5, in step S503, the user e-mails at least one electronic document to a destination e-mail address on MPS server 103. As described above, the destination e-mail address preferably includes the destination identifier and a domain server name. Alternatively, the destination identifier may be contained in any part of the e-mail message. Upon receipt of the e-mail, the MPS server 103, in step S504, dynamically allocates storage space for each e-mail and the associated electronic document transmitted to the destination e-mail address. Then, in step S505, MPS server 103 proceeds to render the received e-mail and the associated electronic document to print-ready format (i.e., print job) in the rendering server (not shown).

In another embodiment, the MPS server 103 generates a notification e-mail to the source e-mail address in response to receiving the electronic document. The notification e-mail may contain information such as number of pages and total cost for printing the electronic document. In a case where a sub-domain name of the destination e-mail address is detected by the MPS server 103, where the sub-domain name represents an instruction, the price information corresponding to the specific instruction, such as finishing options, color or black and white copy, or page-count information of the sub-domain name will be presented to the user through the notification e-mail. Preferably, along with the notification e-mail message, is a list of instructions of how to obtain additional information regarding the print job. To obtain this additional information, the user transmits a reply e-mail to the notification e-mail. For example, the user may reply with an e-mail to the MPS server 103 by including the word “page count” in the subject line of the reply e-mail to obtain the number of pages for the electronic document. Upon receiving the reply e-mail, the MPS server 103 returns another e-mail with the requested information (e.g., page count) to the user via e-mail. In addition, the user may supply printing options such as number of copies or pages to copy in the reply e-mail.

When the user wishes to print the print job, in step S506, the user submits identification account information to the MPS server 103 by swiping a magnetic stripe card that contains the number or portion of the number corresponding to the identification-code of the destination identifier associated with the electronic document to be printed at a card reader. Alternatively, the user may enter the card information via a manual input device, such as a touch screen monitor.

In response to swiping the card in step S506, the card reader reads the encoded information of the card and transmits the information to network interface device 400. Then, the network interface device 400 sends the information to MPS server 103.

In step S507, the MPS server 103 queries the database server 313 for at least one print job that is associated with the corresponding received card information. In a case where the received card information does not match with any print job on the MPS server 103, in step S508, the MPS server 103 notifies the network interface device 400 that no pending print job is available. In a case where at least one print job with the associated destination identifier corresponds to the card information, then in step S509, a display screen (not shown) displays the at least one print job along with the destination identifier. The display screen may be a monitor that is incorporated in the printer, network interface device, or card reader. Alternatively, the display screen may be an external display device that communicates with network 100. The user then selects the desired print job(s) for printing. In response to the user's selection, in step S510, the transaction agent calculates the final price for printing the selected print job(s).

Next, in step S511, if the user wishes to proceed with printing the print job(s) at the determined price, the transaction agent verifies the payment method with the identification account information using payment server 314. Upon verification, payment is executed at the determined price and the print job(s) printed (step S513). Flow then proceeds to step S512, where the user is given the option of keeping or deleting the print job(s) on the MPS server 103. If the user decides to keep the print job(s), then the print job(s) remains on the MPS sever 103 (step S515). If the user decides not keep the print job(s) on the MPS server 103, then the print job(s) is/are deleted from the MPS server 103 (step S514).

Returning to step S511, if the user does not wish to proceed with printing the document, flow proceeds to steps S512 and S514 or S515 as previously described.

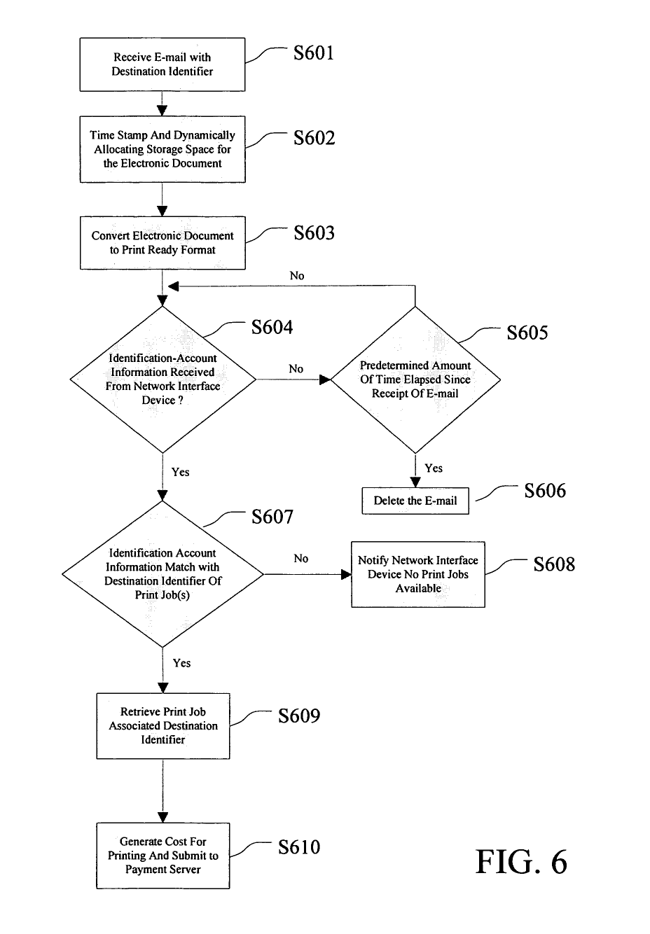

FIG. 6 is a flowchart depicting the processing steps performed by the MPS server 103 of the present invention. Briefly, the MPS server 103 receives an e-mail with an electronic document and a destination identifier, dynamically allocates storage space for the e-mail and electronic document, receives and verifies identification-information corresponding to the stored electronic document, and upon successful verification of the identification-information, retrieves a print job associated with destination identifier.

In more detail, in step S601, the MPS server 103 receives an e-mail that preferably includes an electronic document and a destination identifier. Upon receipt of the e-mail, the MPS server 103 time stamps the e-mail (step S602). In addition, information from the e-mail such as file data, number of pages, source e-mail address and destination e-mail address are collected by the MPS server 103. Also in step S602, the MPS server 103 dynamically allocates storage space for the e-mail message and the associated electronic document. The MPS server 103 may receive multiple e-mails with electronic documents with the same destination identifiers, where the e-mails can be stored together with the corresponding destination identifiers.

Next, in step S603, rendering server 311 of the MPS server 103 converts the received e-mail and the associated electronic document(s) to print ready format (i.e., print job). Typically, only the electronic document will be printed, but the e-mail is rendered as well in the event a user wishes to print the e-mail itself. The time stamp and other information related to the electronic document may be stored in a table together with the print job and the destination identifier.

In a case where a sub-domain name of the destination e-mail address is detected by the MPS server 103, the MPS server 103 generates a notification e-mail with information associated with the sub-domain name to the source e-mail address. For example, if the sub-domain name contains the words “page count”, the MPS server 103 will return the number of pages of the print job, and the total cost for printing the print job via a notification e-mail. If the sub-domain name contains the word “color”, the MPS server 103 will return a notification e-mail to the user with the cost of printing the print job in color.

In step S604, the MPS server 103 waits for the network interface device 400 to submit the identification account information. If no identification account information is received by the MPS server 103, then in step S605 a determination is made whether a predetermined amount of time has elapsed since receipt of a particular e-mail. The time stamp assigned to the e-mail in step S602 is preferably used in making this determination.

If it is determined that the predetermined amount of time has elapsed since receipt of the e-mail, then flow proceeds to step S606, where the e-mail and associated electronic document(s) are deleted from the MPS server 103. If it is determined that the predetermined amount of time has not elapsed, flow returns to step S604.

Returning to step S604, if the MPS server 103 receives identification account information from a network interface device 400, the in step S607, MPS server 103 queries the correspondence table to determine if the destination identifier matches the identification account information received from the network interface device 400. If the received identification account information does not match with the destination identifier in the table, then in step S608, the MPS server 103 sends a notification message to the network interface device 400 that there are no pending print jobs associated with the received identification account information. If however, the received identification account information matches with a destination identifier in the table, then in step S609, the MPS server 103 retrieves the stored print job(s) corresponding to the destination identifier and transmits the name of the print job(s) to the network interface device 400. In one embodiment, secure transmission of the name of the print job(s) is done via SSL. The present invention is not limited to this method of secure transmission, and any secure transmission method that would allow practice of the present invention is applicable.

In step S610, a payment server 314 may be used to calculate the price of printing the document. The transaction agent (not shown), a software program within the payment server 314, is responsible for determining the price of printing the electronic document, executing the payment, and initiating the print job. The transaction agent also provides finishing options such as paper size, color copies, number of copies, etc. After receiving the selected finishing options, the transaction agent proceeds to execute payment via a secure payment gateway such as VeriSign®. Upon successful execution, the MPS server 103 sends the print job to the printing device for printing. As in the case of transmission of the name of the print job, in one embodiment, secure transmission of the print job to the printing device is performed using SSL. However, any method of secure transmission that would enable practice of the present invention is applicable.

The invention has been described with particular illustrative embodiments. It is to be understood that the invention is not limited to the above-described embodiments and that various changes and modifications may be made by those of ordinary skill in the art without departing from the spirit and the scope of the invention.

What is claimed is:

1. A method of ad-hoc printing, comprising:
dynamically creating a destination identifier;
transmitting the destination identifier and at least one electronic document to a destination e-mail address via an e-mail message;
storing the at least one electronic document with the destination identifier on a server;
inputting identification-account information;
verifying the inputted identification-account information with the destination identifier stored on the server;
retrieving the at least one electronic document associated with the destination identifier from the server upon verification; and
printing the retrieved electronic document.

2. The method according to claim 1, wherein the destination identifier comprises a user-identifier and an identification-code.

3. The method according to claim 2, wherein the user-identifier comprises at least a user's name.

4. The method according to claim 3, wherein the user-identifier further comprises at least a portion of the user's home address.

5. The method according to claim 2, wherein the identification-code comprises a number.

6. The method according to claim 5, wherein the number is a portion of a number, wherein the entire number is stored as data on a recording medium.

7. The method according to claim 6, wherein the recording medium is a card.

8. The method according to claim 7, wherein the card is a credit card, debit card, prepaid card, or smart card.

9. The method according to claim 5, wherein the number corresponds to a number stored as data on a recording medium.

10. The method according to claim 9, wherein the recording medium is a card.

11. The method according to claim 10, wherein the card is a credit card, debit card, prepaid card, or smart card.

12. The method according to claim 1, wherein the destination identifier is contained in the destination e-mail address.

13. The method according to claim 1, wherein the destination identifier is contained in any part of the e-mail message.

14. The method according to claim 1, wherein the identification-account information is inputted via a recording medium reader.

15. The method according to claim 1, wherein the identification-account information is manually inputted.

16. The method according to claim 1, wherein the at least one electronic document is stored on the server for a predetermined length of time.

17. The method according to claim 1, wherein the at least one electronic document is stored on the server for an unspecified length of time.

18. The method according to claim 1, further comprising automatically generating an e-mail message from the server in response to storing the at least one electronic document with the destination identifier on the server.

19. The method according to claim 1, further comprising a transaction agent for determining the price for printing the retrieved at least one electronic document and executing a payment transaction.

20. The method according to claim 1, wherein the destination e-mail address contains a sub-domain name.

21. The method according to claim 20, wherein the sub-domain name provides additional functionality.

22. The method according to claim 21, wherein the additional functionality includes finishing options and requests for page count and requests for costs for black and white printing and color printing.

23. The method according to claim 21, further comprises automatically generating an e-mail message from the server with information regarding the additional functionality associated with the sub-domain name.

24. A system for ad-hoc printing, comprising:
a host terminal;
a server;
a network interface device;
a printing device;
wherein the host terminal transmits an e-mail message with a dynamically generated destination identifier to a destination e-mail address,
wherein the server receives the e-mail message and the destination identifier transmitted by the host terminal, receives recorded medium information from the network interface device, and transmits to the network interface device print data corresponding to the destination identifier,
wherein the network interface device transmits recorded medium information to the server, receives print data corresponding to the destination identifier from the server, and transmits the print data to a printing device,
wherein the printing device receives the print data and outputs the print data.

25. Computer-executable process steps for ad-hoc printing, comprising the steps of:
a creating step for dynamically creating a destination identifier;
a transmitting step for transmitting the destination identifier and at least one electronic document to a destination e-mail address via an e-mail message;
a storing step for storing the at least one electronic document with the destination identifier on a server;
an inputting step for inputting identification-account information;
a verification step for verifying the inputted identification-account information with the destination identifier stored on the server;
a retrieving step for retrieving the at least one electronic document associated with the destination identifier from the server upon verification; and
a printing step for printing the retrieved electronic document.

26. Computer-executable process steps for ad-hoc printing according to claim 25, wherein the destination identifier comprises a user-identifier and an identification-code.

27. Computer-executable process steps for ad-hoc printing according to claim 26, wherein the user-identifier comprises at least a user's name.

28. Computer-executable process steps for ad-hoc printing according to claim 27, wherein the user-identifier further comprises at least a portion of the user's home address.

29. Computer-executable process steps for ad-hoc printing according to claim 26, wherein the identification-code comprises a number.

30. Computer-executable process steps for ad-hoc printing according to claim 29, wherein the number is a portion of a number, wherein the entire number is stored as data on a recording medium.

31. Computer-executable process steps for ad-hoc printing according to claim 30, wherein the recording medium is a card.

32. Computer-executable process steps for ad-hoc printing according to claim 31, wherein the card is a credit card, debit card, prepaid card, or smart card.

33. Computer-executable process steps for ad-hoc printing according to claim 29, wherein the number corresponds to a number stored as data on a recording medium.

34. Computer-executable process steps for ad-hoc printing according to claim 33, wherein the recording medium is a card.

35. Computer-executable process steps for ad-hoc printing according to claim 34, wherein the card is a credit card, debit card, prepaid card, or smart card.

36. Computer-executable process steps for ad-hoc printing according to claim 25, wherein the destination identifier is contained in the destination e-mail address.

37. Computer-executable process steps for ad-hoc printing according to claim 25, wherein the destination identifier is contained in any part of the e-mail message.

38. Computer-executable process steps for ad-hoc printing according to claim 25, wherein the identification-account information is inputted via a recording medium reader.

39. Computer-executable process steps for ad-hoc printing according to claim 25, wherein the identification-account information is manually inputted.

40. Computer-executable process steps for ad-hoc printing according to claim 25, wherein the at least one electronic document is stored on the server for a predetermined length of time.

41. Computer-executable process steps for ad-hoc printing according to claim 25, wherein the at least one electronic document is stored on the server for an unspecified length of time.

42. Computer-executable process steps for ad-hoc printing according to claim 25, further comprising automatically generating an e-mail message from the server in response to storing the at least one electronic document with the destination identifier on the server.

43. Computer-executable process steps for ad-hoc printing according to claim 25, further comprising a transaction agent for determining the price for printing the retrieved at least one electronic document and executing a payment transaction.

44. Computer-executable process steps for ad-hoc printing according to claim 25, wherein the destination e-mail address contains a sub-domain name.

45. Computer-executable process steps for ad-hoc printing according to claim 44, wherein the sub-domain name provides additional functionality.

46. Computer-executable process steps for ad-hoc printing according to claim 45, wherein the additional functionality includes finishing options and requests for page count and requests for costs for black and white printing and color printing.

47. Computer-executable process steps for ad-hoc printing according to claim 45, further comprises automatically generating an e-mail message from the server with information regarding the additional functionality associated with the sub-domain name.
